(19) United States
(12) Patent Application Publication
(10) Pub. No.: US 2016/0236016 A1
(43) Pub. Date: Aug. 18, 2016

(54) BREATHING APPARATUS

(71) Applicant: SHIGEMATSU WORKS CO., LTD., Tokyo (JP)

(72) Inventors: Kenichi Ono, Saitama (JP); Hiroyuki Ide, Saitama (JP); Genta Santou, Saitama (JP)

(21) Appl. No.: 14/620,445

(22) Filed: Feb. 12, 2015

(51) Int. Cl. A62B 23/02; A62B 18/08; A62B 18/02; A62B 7/10; A62B 9/02

(52) U.S. Cl. CPC A62B 23/025; A62B 7/10; A62B 9/02; A62B 18/02; A62B 18/025; A62B 18/084

(57) ABSTRACT

[Object of the Invention] An object of the present invention is to provide a breathing apparatus comprising a face piece for covering the whole face or part of the face provided with a hole at each side portion, a motor fan for supplying the face piece with external air, a pressure sensor for monitoring internal pressure of the face piece, a controller for controlling the operation of the motor fan based on a detection signal from the pressure sensor, a filter for purifying the external air supplied to the face piece, and an inhale valve and an exhale valve, wherein filter consumption is minimized.

[Disclosure of the Invention] A breathing apparatus comprises a face piece for covering the whole face or part of the face provided with a hole at each side portion, a motor fan for supplying the face piece with external air, a pressure sensor for monitoring internal pressure of the face piece, a controller for controlling the operation of the motor fan based on a detection signal from the pressure sensor, a filter for purifying the external air supplied to the face piece, and an inhale valve and an exhale valve, wherein a positive pressure exhale valve is attached to one of the holes at the side portions of the face piece and a positive pressure exhale valve or a voice conductor is attached to the other of the holes at the side portions of the face piece.

### TECHNICAL FIELD

The present invention relates to a breathing apparatus comprising a face piece for covering the whole face or part of the face provided with a hole at each side portion, a motor fan for supplying the face piece with external air, a pressure sensor for monitoring internal pressure of the face piece, a controller for controlling the operation of the motor fan based on a detection signal from the pressure sensor, a filter for purifying the external air supplied to the face piece, and an inhale valve and an exhale valve.

### BACKGROUND ART

Patent Document No. 1 discloses a breathing apparatus comprising a face piece for covering the whole face or part of the face provided with a hole at each side portion, a motor fan for supplying the face piece with external air, a pressure sensor for monitoring internal pressure of the face piece, a controller for controlling the operation of the motor fan based on a detection signal from the pressure sensor, a filter for purifying the external air supplied to the face piece, and an inhale valve and an exhale valve, wherein an exhale valve is attached to each of the holes at the side portions of the face piece.

The exhale valve provided on the breathing apparatus of Patent Document No. 1 is a rubber product comprising an annular valve seat, a circular rubber film abutted on the valve seat at a peripheral portion, and a support arm fixed to a center portion of the circular rubber film at one end.

In the breathing apparatus of Patent Document No. 1, the controller recognizes inhalation and exhalation based on fluctuation of the internal pressure of the face piece so as to drive the motor fan during inhalation and stop the motor fan or decrease rotation speed of the motor fan during exhalation. The internal pressure of the face piece is always kept positive during operation of the breathing apparatus.

### PRIOR ART DOCUMENT

### Patent Document

Patent Document No. 1: Japanese Patent Laid-Open No. 2011-078604

### DISCLOSURE OF INVENTION

### Problem to be Solved

The breathing apparatus of Patent Document No. 1 has an advantage in that the pair of exhale valves are made of rubber film, so that the exhale valves have low opening pressure that makes exhalation easy. On the other hand, it has a disadvantage in that internal air of the face piece is apt to be discharged to the exterior through the exhale valves due to the low opening pressure of the exhale valves, so that rotation speed of the motor fan is apt to increase excessively during inhalation to compensate for leakage of air from the face piece through the exhale valves, or the timing of stopping the motor fan or the timing of decreasing rotation speed of the motor fan is apt to be delayed, due to delay of increase of the internal pressure of the face piece during transition from inhalation to exhalation. Thus, an unnecessary amount of air passes through the filter, which increases the amount of air passing through the filter and increases the rate of filter consumption.

The present invention is directed to solving the aforementioned problem. An object of the present invention is to provide a breathing apparatus comprising a face piece for covering the whole face or part of the face provided with a hole at each side portion, a motor fan for supplying the face piece with external air, a pressure sensor for monitoring internal pressure of the face piece, a controller for controlling the operation of the motor fan based on a detection signal from the pressure sensor, a filter for purifying the external air supplied to the face piece, and an inhale valve and an exhale valve, wherein filter consumption is minimized.

### Means for Achieving the Object

In accordance with the present invention, there is provided a breathing apparatus comprising a face piece for covering the whole face or part of the face provided with a hole at each side portion, a motor fan for supplying the face piece with external air, a pressure sensor for monitoring internal pressure of the face piece, a controller for controlling the operation of the motor fan based on a detection signal from the pressure sensor, a filter for purifying the external air supplied to the face piece, and an inhale valve and an exhale valve, wherein a positive pressure exhale valve is attached to one of the holes at the side portions of the face piece and a positive pressure exhale valve or a voice conductor is attached to the other of the holes at the side portions of the face piece.

In the breathing apparatus in accordance with the present invention, the exhale valve is a positive pressure exhale valve whose opening pressure is higher than that of the conventional rubber exhale valve and whose resistance to opening is greater than that of the conventional rubber exhale valve, so that internal air of the face piece is relatively hard to discharge to the exterior through the exhale valve. As a result, leakage of air from the face piece through the exhale valve is suppressed during inhalation, so that rotation speed of the motor fan is efficiency-optimized during inhalation, and internal pressure of the face piece rapidly increases during transition from inhalation to exhalation, with the result that timing of stopping the motor fan or timing of decreasing rotation speed of the motor is advanced. Thus, passing of an unnecessary amount of air through the filter is suppressed, and the amount of air passing through the filter during operation of the breathing apparatus decreases. Therefore, in the breathing apparatus of the present invention, filter consumption rate is minimized although ease of breathing decreases a bit compared with the conventional breathing apparatus whose exhale valves are conventional rubber valves.

It is possible to provide each of the holes at the side portions of the face piece with a positive pressure exhale valve, or provide one of the holes at the side portions of the face piece with a positive pressure exhale valve and the other of the holes at the side portions of the face piece with a voice conductor.

When each of the holes at the side portions of the face piece is provided with a positive pressure exhale valve, filter consumption is suppressed. When one of the holes at the side portions of the face piece is provided with a positive pressure exhaust valve and the other of the holes at the side portions of the face piece is provided with a voice conductor, consumption of the filter is additionally suppressed, and besides, the other of the holes can be used effectively as a voice conductor attaching hole instead of being left unused and simply closed.

### BRIEF DESCRIPTION OF THE DRAWINGS

FIG. 1 is a set of front views of a breathing apparatus in accordance with a preferred embodiment of the present invention. (a) is a front view in completed condition and (b) is a front view wherein an exhale valve is shown in exploded perspective view.

FIG. 2 is a set of structural views of a fan unit provided on a breathing apparatus in accordance with a preferred embodiment of the present invention. (a) is a front view, (b) is a side view, (c) is a rear side view, (d) is a view in the direction of an arrow A in (a), (e) is a sectional view taken along line B-B in (d), and (f) is a view in the direction of arrows C-C in (b).

FIG. 3 is a set of structural views of a face piece and a nose cup provided on a breathing apparatus in accordance with a preferred embodiment of the present invention. (a) is a front view of a face piece, (b) is a sectional view taken along line D-D in (a), (c) is a fragmentary front view of the face piece showing a hole formed at one of the side portions of the face piece, and (d) is a fragmentary front view of the face piece showing a hole formed at the other of the side portions of the face piece.

FIG. 4 is a set of structural views of a nose cup provided on a breathing apparatus in accordance with a preferred embodiment of the present invention. (a) is a front view, (b) is a rear side view, and (c) is a sectional view taken along line E-E in (a).

FIG. 5 is a set of sectional views of an exhale valve of a breathing apparatus in accordance with a preferred embodiment of the present invention. (a) is a view showing the exhale valve in closed condition and (b) is a view showing the exhale valve in open condition.

### MODES FOR CARRYING OUT THE INVENTION

A breathing apparatus in accordance with a preferred embodiment of the present invention will be described.

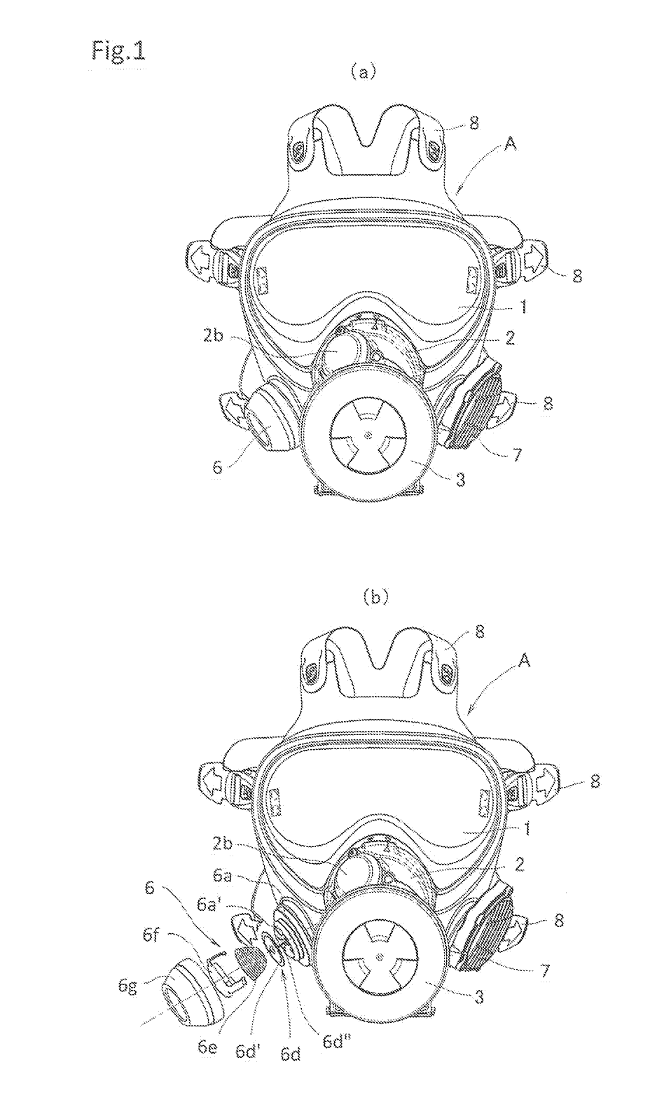

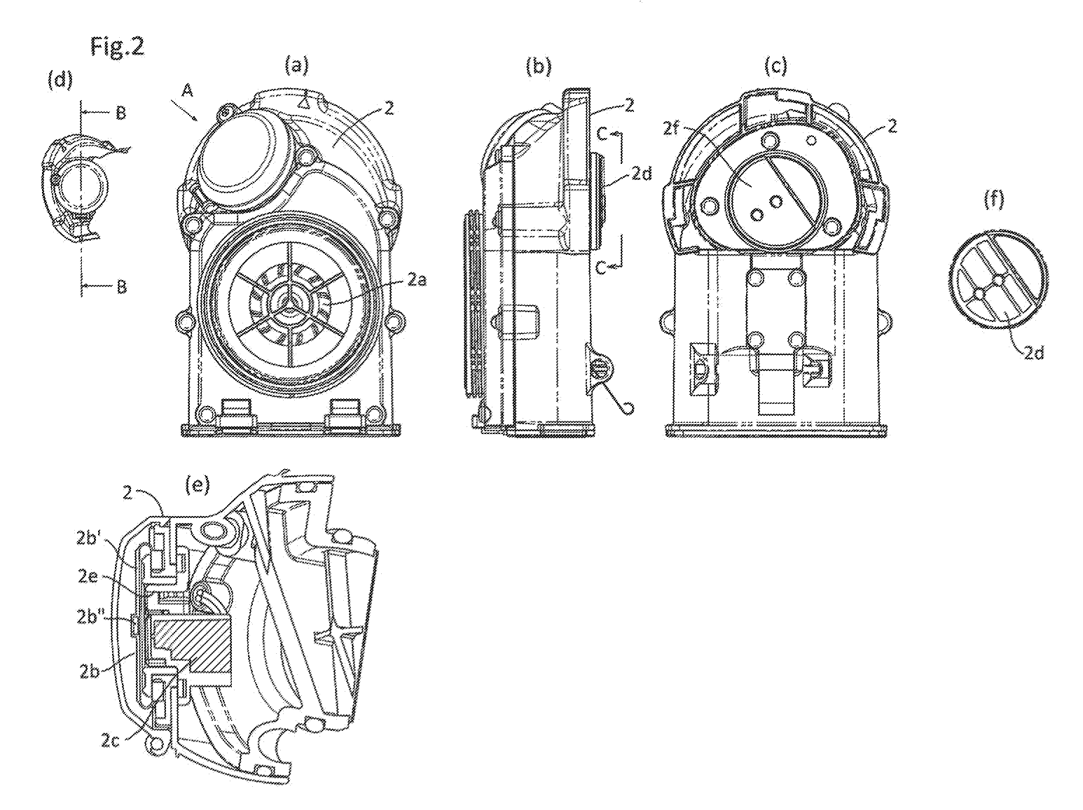

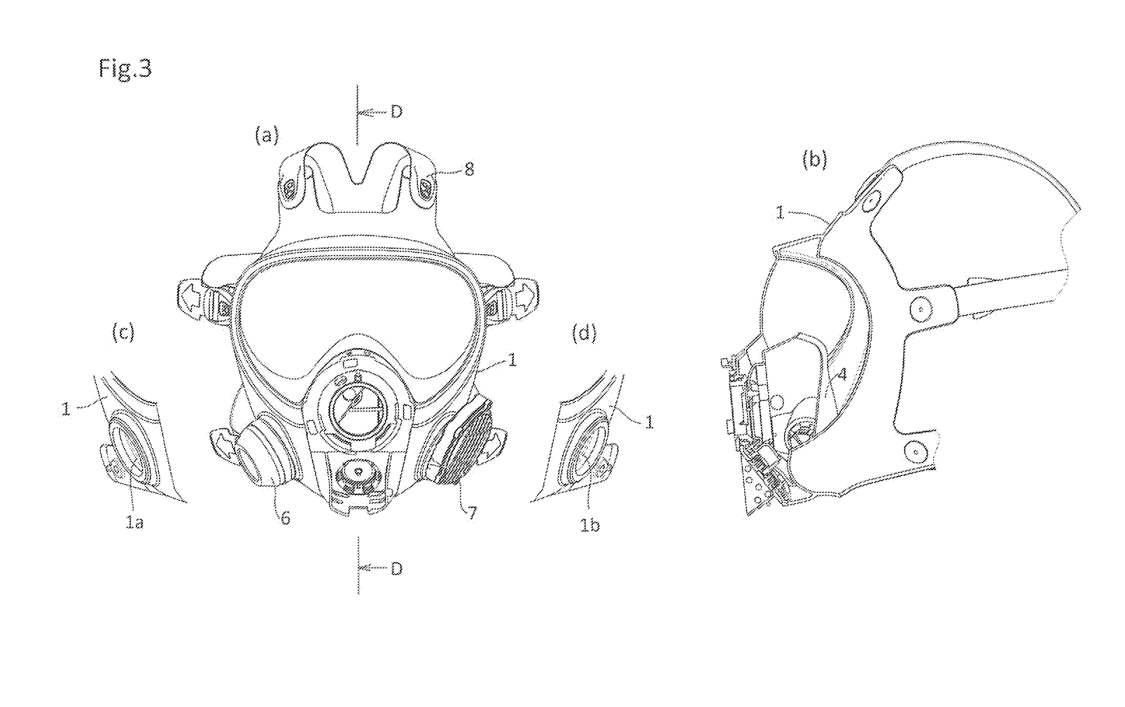

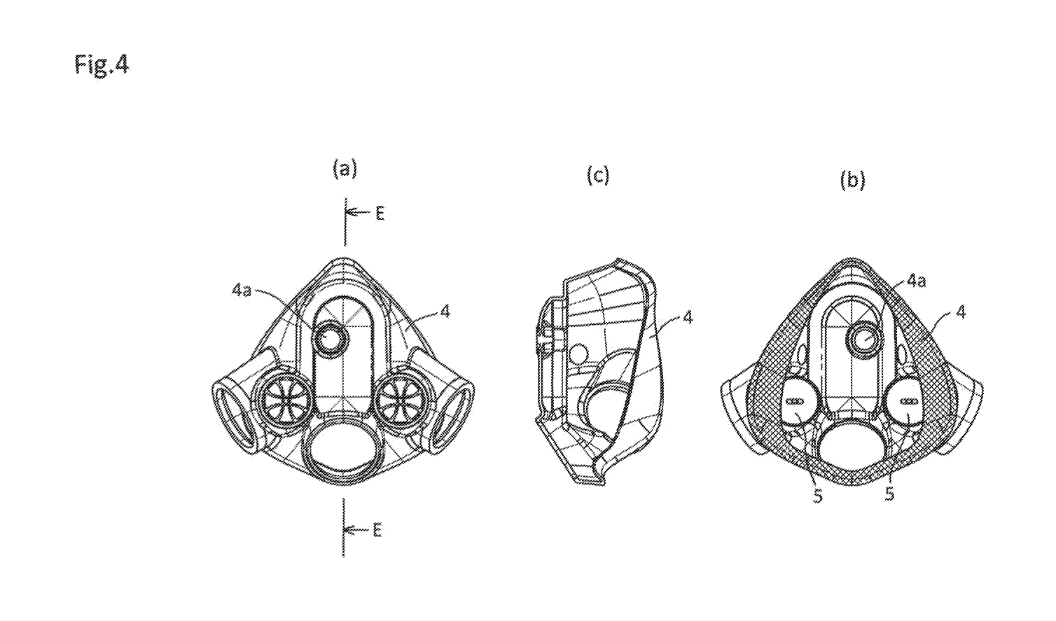

As shown in FIGS. 1 to 4, a breathing apparatus A comprises a bowl-shaped face piece 1 for covering the whole face of a user of the breathing apparatus A, a fan unit 2 detachably attached to the front surface of the face piece 1 so as to accommodate a motor fan 2a for supplying the face piece 1 with air, a pressure sensor 2b for detecting internal pressure of the face piece 1 comprising a diaphragm 2b′ and a magnetic sensor or an optical sensor 2b″, and a controller 2c for controlling the operation of the motor fan 2a based on detection signals from the pressure sensor 2b, a filter 3 detachably attached to the front surface of the fan unit 2 so as to purifying the air supplied to the face piece 1, a nose cup 4 detachably attached to the face piece 1 so as to cover a user's nose and mouth, inhale valves 5 attached to the nose cup 4 so as to communicate with an air outlet 2d of the fan unit 2, an exhale valve 6 attached to a hole 1a formed at one of the side portions of the face piece 1 so as to communicate with the internal space of the nose cup 4, a voice conductor 7 attached to a hole 1b formed at the other of the side portions of the face piece 1 so as to communicate with the internal space of the nose cup 4, and fastening belts 8 for fixing the face piece 1 to the head of the user. A space in the fan unit 2 for accommodating the pressure sensor 2b communicates with the internal space of the nose cup 4 through a communication passage 2e formed in the fan unit 2 and a communication passage 4a formed in the nose cup 4. The fan unit 2 is provided with a check valve 2f disposed immediately upstream of the air outlet 2d.

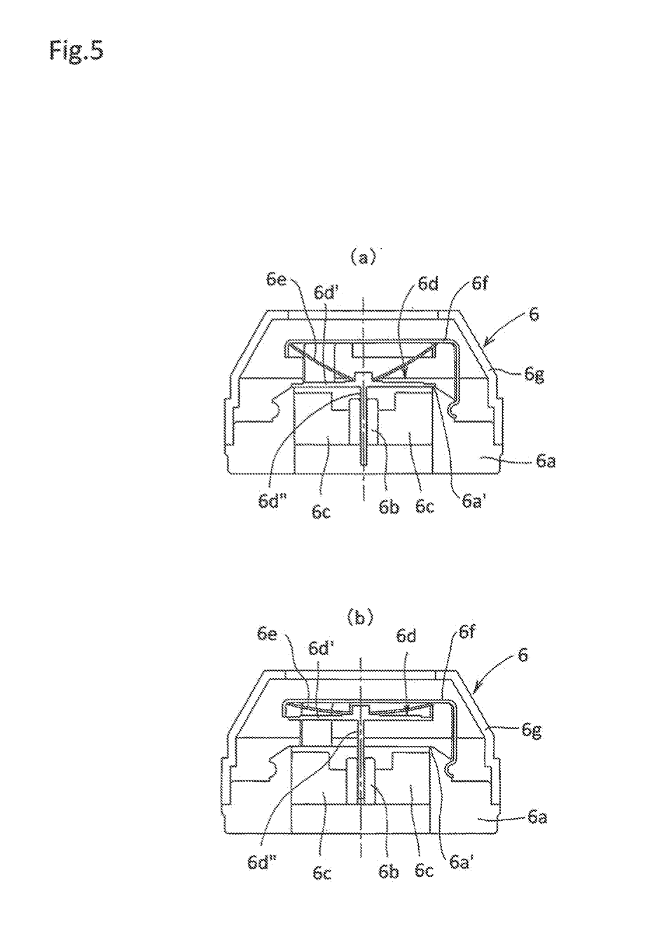

The exhale valve 6 is a positive pressure exhale valve of the type conventionally used in pressure-demand type breathing apparatuses. As shown in FIG. 1(b) and FIG. 5, the exhale valve 6 comprises a cylindrical valve seat forming member 6a provided with an annular valve seat 6a′ and fitted in and fixed to the hole 1a formed at one of the side portions of the face piece 1, a cylindrical body 6b disposed in a central opening of the valve seat forming member 6a and extending coaxially with the valve seat forming member 6a, a plurality of arm members 6c extending from the inner circumferential surface of the valve seat forming member 6a and supporting the cylindrical body 6b, a valve body 6d comprising a hard circular disk body 6d′ capable of abutting the valve seat 6a′ at the peripheral portion, and a shaft body 6d″ extending from the center of one of the end surfaces of the hard circular disk body 6d′ at right angles to the said end surface and inserted in the cylindrical body 6b, a coil spring 6e engaged to the other of the end surfaces of the hard circular disk body 6d′ at one end and forcing the valve body 6d toward the valve seat 6a′, a coil spring retainer 6f engagingly locked on the valve seat forming member 6a and engaging the other end of the coil spring 6e, thereby retaining the coil spring 6e, and a conically cylindrical exhale valve cover 6g engagingly locked on the valve seat forming member 6a and covering the coil spring retainer 6f.

The voice conductor 7 is fitted in and fixed to the hole 1b formed at the other of the side portions of the face piece 1.

In the breathing apparatus A, the motor fan 2a accommodated in the fan unit 2 operates. External air passes through the filter 3 to be purified. Purified air flows into the nose cup 4 through the check valve 2f, the air outlet 2d of the fan unit 2 and the inhale valves 5 so as to be used by a user of the breathing apparatus A as inhalation air. Exhalation air of the user is discharged out of the face piece 1 through the exhale valve 6.

Internal pressure of the face piece 1, more concretely internal pressure of the nose cup 4, fluctuates corresponding to the breathing of the user, so that internal pressure of a space in the fan unit 2 accommodating the pressure sensor 2b fluctuates, and the diaphragm 2b′ of the pressure sensor 2b displaces. The magnetic sensor or the optical sensor 2h″ detects the displacement of the diaphragm 2b′, and the magnetic sensor or the optical sensor 2h″ sends detection signals to the controller 2c. The controller 2c controls the operation of the motor fan 2a corresponding to the internal pressure of the space accommodating the pressure sensor 2b. The motor fan 2a operates during inhalation of the user of the breathing apparatus A so as to supply the face piece 1, more concretely the nose cup 4, with air. The motor fan 2a stops or rotation speed of the motor fan 2a decreases during exhalation of the user of the breathing apparatus A. As a result, the internal pressure of the face piece 1 is always kept at normal positive pressure. Furthermore, the operation of the motor fan 2a is efficiency-optimized and the lifetime of the battery of the motor fan 2a is prolonged.

A single exhale valve 6 is disposed in the breathing apparatus A. The exhale valve 6 is a positive pressure exhale valve whose opening pressure is higher than that of the conventional rubber exhale valve and whose resistance to opening is greater that of the conventional rubber exhale valve, so that internal air of the face piece 1 is relatively hard to discharge to the exterior through the exhale valve 6. As a result, in the breathing apparatus A, leakage of air from the face piece 1 through the exhale valve 6 is suppressed during inhalation, so that rotation speed of the motor fan 2a is efficiency-optimized during inhalation, and internal pressure of the face piece 1 rapidly increases during transition from inhalation to exhalation, so that timing of stopping the motor fan 2a or timing of decreasing rotation speed of the motor fan 2a is advanced. As a result, passing of unnecessary amount of air through the filter 3 is suppressed, and amount of air passing through the filter 3 during operation of the breathing apparatus A decreases. Therefore, in the breathing apparatus A, the consumption rate of the filter 3 is minimized although ease of breathing decreases a bit compared with the conventional breathing apparatus whose exhale valves are conventional rubber valves. One of the holes 1a, 1b at the side portions of the face piece 1 is provided with a positive pressure exhale valve 6 and the other of the holes 1a, 1b at the side portions of the face piece 1 is provided with a voice conductor 5. Thus, the other of the holes 1a, 1b is used effectively as a voice conductor attaching hole instead of being left unused and simply closed.

It is possible to provide each of the holes 1a, 1b at the side portions of the face piece 1 with a positive pressure exhale valve 6. Even if each of the holes 1a, 1b at the side portions of the face piece 1 is provided with a positive pressure exhale valve 6, consumption of the filter 3 is suppressed compared with the case where each of the holes 1a, 1b at the side portions of the face piece 1 is provided with a rubber exhale valve

In the aforesaid embodiment, the face piece 1 is a full face type face piece for covering the whole face. However, the face piece 1 can be a half face type face piece for covering only the nose and the mouth of the user.

The structure of the positive pressure exhale valve 6 is not restricted to the aforesaid structure. The structure of the positive pressure exhale valve 6 should be such that its opening pressure is higher than that of a conventional rubber exhale valve.

The filter 3 can be a dustproof filter or a gas filter.

The pressure sensor 2b is not restricted to that comprising a diaphragm. Any type of pressure sensor capable of detecting internal pressure of the face piece 1 can be used as the pressure sensor 2b.

The fan unit 2 need not necessarily accommodate the pressure sensor 2b and/or the controller 2c. The pressure sensor 2b and/or the controller 2c can be located out of the fan unit 2.

The present invention can be widely used for breathing apparatuses comprising a face piece for covering the whole face or part of the face provided with a hole at each side portion, a motor fan for supplying the face piece with external air, a pressure sensor for monitoring internal pressure of the face piece, a controller for controlling the operation of the motor fan based on a detection signal from the pressure sensor, a filter for purifying the external air supplied to the face piece, and an inhale valve and an exhale valve.

### BRIEF DESCRIPTION OF THE REFERENCE NUMERALS

A Breathing apparatus
1 Face piece
2 Fan unit
2a Motor fan
2b Pressure sensor
2b′ Diaphragm
2h″ Magnetic sensor or optical sensor
2c Controller
2d Air outlet
2e Communication passage
2f Check valve
3 Filter
4 Nose cup
5 Inhale valve
6 Exhale valve
7 Voice conductor
8 Fastening belt

1. A breathing apparatus comprising a face piece for covering the whole face or part of the face provided with a hole at each side portion, a motor fan for supplying the face piece with external air, a pressure sensor for monitoring internal pressure of the face piece, a controller for controlling the operation of the motor fan based on a detection signal from the pressure sensor, a filter for purifying the external air supplied to the face piece, and an inhale valve and an exhale valve, wherein a positive pressure exhale valve is attached to one of the holes at the side portions of the face piece and a positive pressure exhale valve or a voice conductor is attached to the other of the holes at the side portions of the face piece.
